(19) United States
(12) Patent Application Publication
(10) Pub. No.: US 2011/0283324 A1
(43) Pub. Date: Nov. 17, 2011

(54) METHOD AND APPARATUS OF DIGITAL BROADCASTING SERVICE USING AUTOMATIC KEYWORD GENERATION

(75) Inventor: Bong Jin OH, Daejeon (KR)

(73) Assignee: Electronics and Telecommunications Research Institute, Daejeon (KR)

(21) Appl. No.: 13/086,692

(22) Filed: Apr. 14, 2011

(30) Foreign Application Priority Data
Apr. 14, 2010 (KR) 10-2010-0034428

(51) Int. Cl. H04N 5/445; H04N 7/173

(52) U.S. Cl. 725/53; 725/109

(57) ABSTRACT

Disclosed are an apparatus and a method of providing a digital broadcasting service by using automatic keyword generation. A voice recognizing device converts a voice into text-format data for each channel and a server extracts a word-unit keyword from received data by a predetermined design, and stores the keyword for each channel. When there is a request from an IPTV terminal, the stored keyword for each channel is retrieved and transmitted. The IPTV terminal requests retrieval associated with the received keyword to a portal and receives a service retrieval result associated with the keyword from the portal. In addition, the IPTV terminal transmits and displays the service retrieval result to and on a TV. According to the present invention, it is possible to automatically generate and manage the keyword for each channel and easily retrieve and provide the service associated with the corresponding keyword, such that viewers can immediately resolve questions about characters or situations of a presently viewed channel to thereby acquire improved satisfaction.

### CROSS-REFERENCE TO RELATED APPLICATIONS

This application claims priority under 35 U.S.C. §119 to Korean Patent Application No. 10-2010-0034428, filed on Apr. 14, 2010, in the Korean Intellectual Property Office, the disclosure of which is incorporated herein by reference in its entirety.

### TECHNICAL FIELD

The present invention relates to an apparatus and a method of providing a digital broadcasting service, and more particularly, to an apparatus and a method of providing a digital broadcasting service using automatic keyword generation.

### BACKGROUND

A television (TV) is a service providing terminal capable of familiarly and easily accessing viewers and broadcasters are being extended to satellite, internet protocol television (IPTV), and digital multimedia broadcasting (DMB) providers from the existing terrestrial and cable broadcasters. Broadcasting services themselves are also in a transition period in which an analog format is switched to a digital format and there is a trend in which contents providers providing channels have increased.

The viewers intend to actively find services and contents associated with information provided by the broadcasters as well as passively view the information provided by the broadcasters. In order to meet the viewers' requirements, a service to retrieve services and contents associated with channels by using keywords directly inputted by the viewers or electronic program guide (EPG) information of a broadcasting stream may be provided.

However, the type in which the viewers directly input the keywords is inconvenient and it is also difficult to select an appropriate keyword. Further, the EPG information is constituted by information such as channels, programs, schedules, and the like, such that there is a limit in which unrelated information is retrieved.

### SUMMARY

An exemplary embodiment of the present invention provides a service providing server, including: a receiving unit receiving data for each channel from a voice recognizing device; an extracting unit extracting a keyword for each channel from the data; a storing unit storing the keyword for each channel; a retrieving unit reading information regarding a corresponding channel from the storing unit in accordance with a request from an IPTV terminal; and a transmitting unit transmitting the information read by the retrieving unit to the IPTV terminal.

The receiving unit may further receive a service retrieval result associated with the keyword for each channel from a portal, the storing unit may further store the service retrieval result associated with the keyword for each channel received by the receiving unit, and the transmitting unit may further transmit a request for service retrieval associated with the keyword for each channel to the portal.

The storing unit may further store EPG for each channel.

Another exemplary embodiment of the present invention provides an IPTV terminal including: an input unit receiving a retrieval request signal, and at least one information of a keyword and a service retrieval result for a channel from a service providing server; a control unit requesting information regarding the corresponding channel to the server when the retrieval request signal of the input unit is present and commanding the service retrieval result of the input unit to be transmitted to a TV when the service retrieval result is included in the information of the input unit; and an output unit transmitting the request of the control unit to the server and transmitting the service retrieval result to the TV in accordance with the command of the control unit.

The information of the input unit may further include an EPG.

The input unit may further receive the service retrieval result from a portal, the control unit may further include a function to request service retrieval associated with the information of the input unit to the portal when the service retrieval result is not included in the information received from the server of the input unit, and the output unit may further transmit the request of the control unit to the portal.

Yet another exemplary embodiment of the present invention provides an IPTV terminal including a keyword generating unit, including: an input unit receiving data from a TV and receiving a service retrieval result associated with a keyword from a portal; a keyword generating unit extracting the keyword from the data of the input unit; an output unit transmitting a service retrieval request associated with the keyword of the keyword generating unit to the portal and transmitting the service retrieval result of the input unit to the TV; and a control unit sending the data of the input unit to the keyword generating unit and commanding the service retrieval result of the input unit to be transmitted to the TV through the output unit.

The data received from the TV of the input unit may be any one of a time, an image capture, and a text capture, and the keyword generating unit may be any one of a voice recognition extracting portion, an image capture extracting portion, and a text capture extracting portion.

The control unit may send the data to the voice recognition extracting portion when the data of the input unit is the time, send the data to the image capture extracting portion when the data the input unit is the image capture, and send the data to the text capture extracting portion when the data of the input unit is the text capture.

Still yet another exemplary embodiment of the present invention provides a method of providing a digital broadcasting service by using automatic keyword generation, the method including: (a) receiving, by a service provider server, data for each channel from a voice recognizing device; (b) extracting, by the server, a keyword from the data; (c) storing, by the server, the keyword in a storing unit; (d) receiving, by the server, a request for channel information from an IPTV terminal; (e) reading, by the server, the channel information from the storing unit; and (f) transmitting, by the server, the read information to the IPTV terminal.

The method may further include: requesting, by the server, service retrieval associated with the keyword for each channel; and receiving, by the server, a service retrieval result from a portal, wherein in step (c), the service retrieval result may be further stored.

In step (c), an EPG may be further stored.

Still yet another exemplary embodiment of the present invention provides a method of providing a digital broadcasting service by using automatic keyword generation, the method including: judging, by an IPTV terminal, whether a retrieval request signal is present; requesting, by the IPTV terminal, information regarding a corresponding channel to a server when the signal is present; receiving, by the IPTV terminal, at least one information of a keyword and a service retrieval result for the channel from the server; judging, by the IPTV terminal, whether the service retrieval result is included in the information received from the server; and transmitting, by the IPTV terminal, the service retrieval result to a TV.

An EPG may be further included in the information received from the server.

The method may further include: requesting, by the IPTV terminal, service retrieval associated with the information to a portal when the service retrieval result is not included in the information; and receiving, by the IPTV terminal, a service retrieval result from the portal.

Still yet another exemplary embodiment of the present invention provides a method of providing a digital broadcasting service by using automatic keyword generation performed by an IPTV terminal including a keyword generator, the method including: (a) judging, by the IPTV terminal, whether or not to receive data from a TV; (b) extracting, by the IPTV terminal, a keyword from the data; (c) requesting, by the IPTV terminal, service retrieval associated with the keyword to a portal; (d) receiving, by the IPTV terminal, a service retrieval result from the portal; and (e) transmitting, by the IPTV terminal, the service retrieval result to the TV.

The data in step (a) may be any one of a time, an image capture, and a text capture.

The method may further include (f) judging a type of the data received from the TV, wherein step (b) may be any one of extracting the keyword based on a voice, extracting the keyword based on the text capture, and extracting the keyword based on the image capture, and in step (f), the keyword may be extracted based on the voice when the data is the time, the keyword may be extracted based on the image capture when the data is the image capture, and the keyword may be extracted based on the text capture when the data is the text capture.

Other features and aspects will be apparent from the following detailed description, the drawings, and the claims.

### BRIEF DESCRIPTION OF THE DRAWINGS

FIG. 1 is an overall configuration diagram of a digital broadcasting service by using automatic keyword generation.

FIG. 2 is a configuration diagram of a server providing a digital broadcasting service by using automatic keyword generation.

FIG. 3 is a configuration diagram of an IPTV terminal providing a digital broadcasting service by using automatic keyword generation.

FIG. 4 is a configuration diagram of an IPTV terminal including a keyword generator.

FIG. 5 is a block diagram of a method for providing a digital broadcasting service by using automatic keyword generation in a server.

FIG. 6 is a block diagram of a method for providing a digital broadcasting service by using automatic keyword generation in an IPTV terminal.

FIG. 7 is a block diagram of a method for providing a digital broadcasting service by using automatic keyword generation in an IPTV terminal including a keyword generator.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

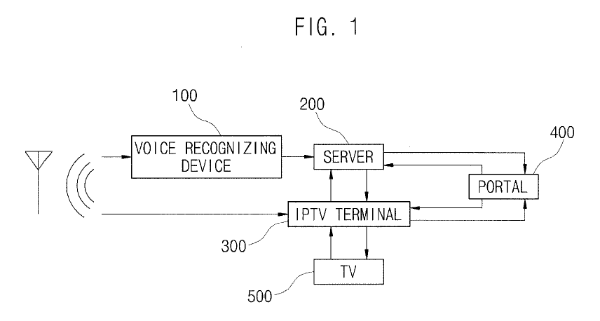

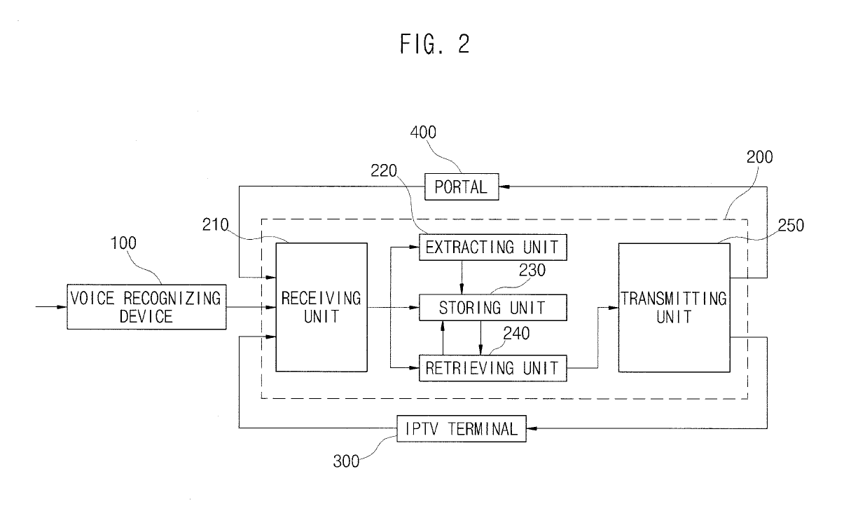

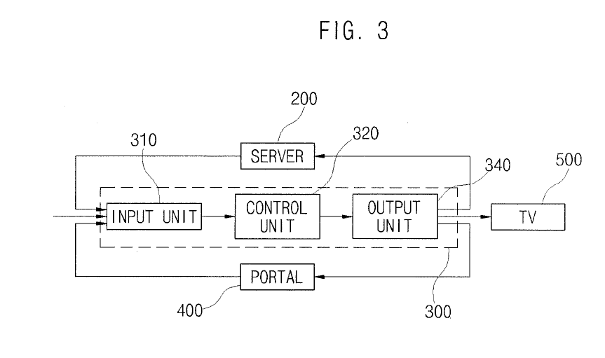

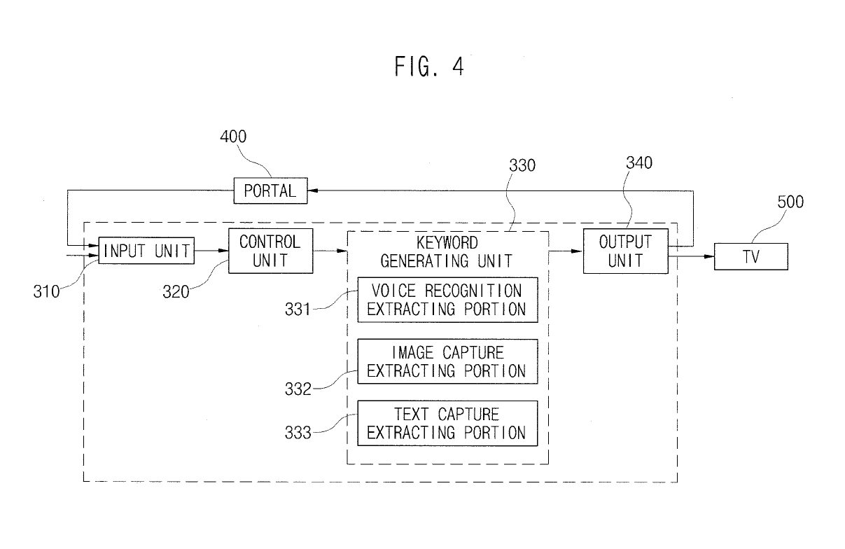

FIG. 1 is an overall configuration diagram of a digital broadcasting service by using automatic keyword generation, FIG. 2 is a configuration diagram of a server providing a digital broadcasting service by using automatic keyword generation, FIG. 3 is a configuration diagram of an IPTV terminal providing a digital broadcasting service by using automatic keyword generation, and FIG. 4 is a configuration diagram of an IPTV terminal including a keyword generator.

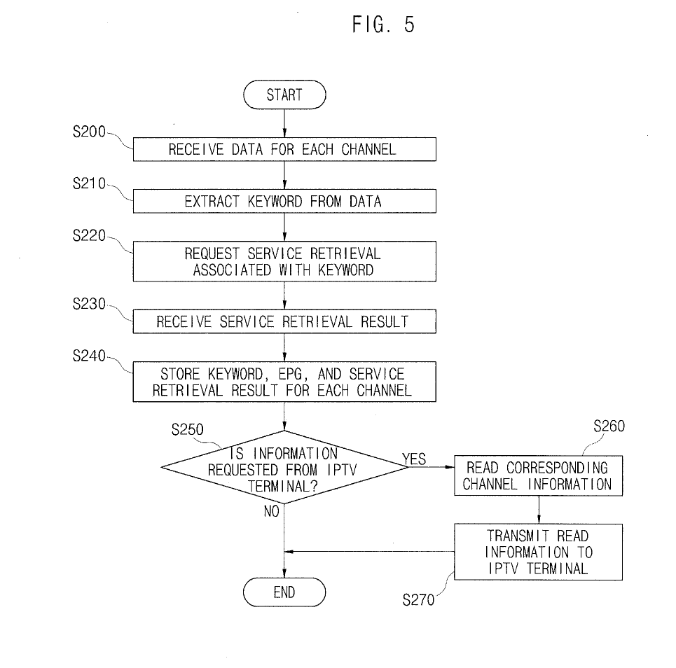

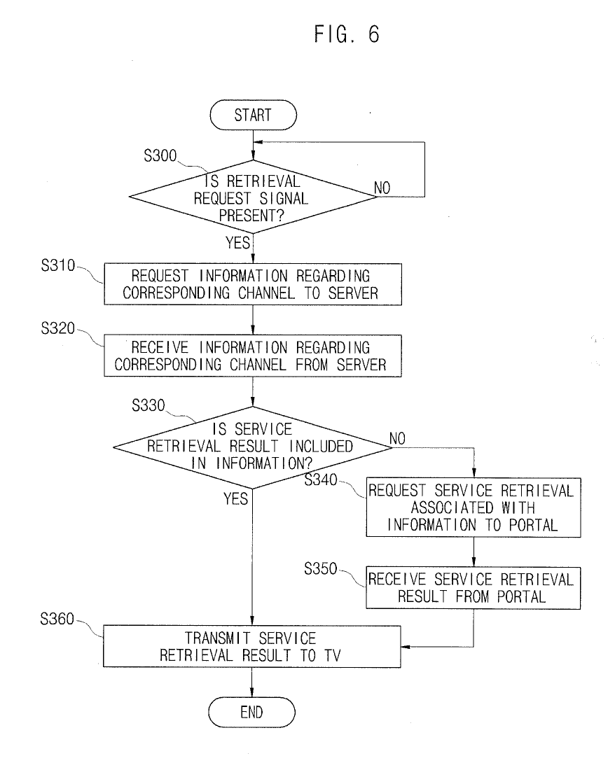

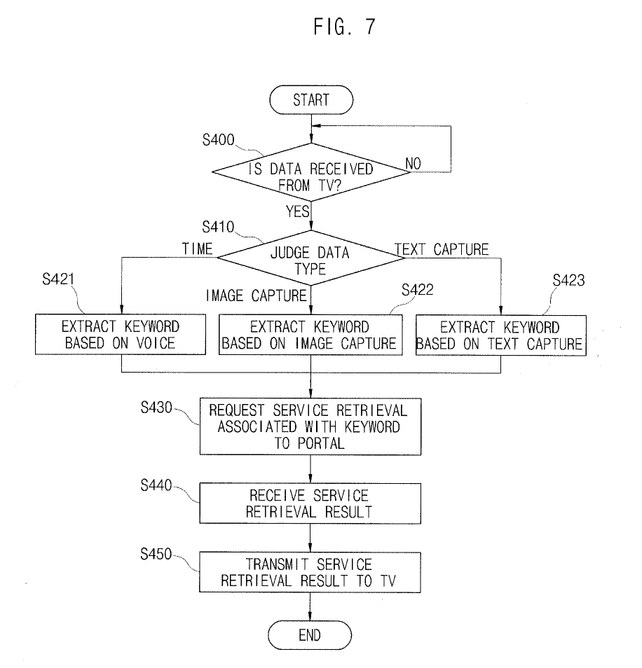

FIG. 5 is a block diagram of a method for providing a digital broadcasting service by using automatic keyword generation in a server, FIG. 6 is a block diagram of a method for providing a digital broadcasting service by using automatic keyword generation in an IPTV terminal, and FIG. 7 is a block diagram of a method for providing a digital broadcasting service by using automatic keyword generation in an IPTV terminal including a keyword generator.

Referring to FIG. 1, the apparatus of providing a digital broadcasting service by using automatic keyword generation according to the exemplary embodiment of the present invention includes a voice recognizing device 100, a service providing server 200, an IPTV terminal 300, a portal 400, and a TV 500. A plurality of voice recognizing devices 100 convert voice from a broadcasting stream for each channel into data which can be analyzed by the service providing server 200. The data may be a text format. The service providing server 200 is connected with the plurality of voice recognizing devices 100 and receives data for each channel from each voice recognizing device 100. The server 200 extracts a word-unit keyword from the received data according to a predetermined design to store the keyword for each channel. When the IPTV terminal 300 requests information regarding a predetermined channel, the server 200 retrieves the stored keyword for each channel and transmits the retrieved keyword to the IPTV terminal 300. The IPTV terminal 300 requests for retrieving the received keyword to a service retrieving system such as the portal 400 and receives a service retrieval result associated with the keyword from the portal 400. The IPTV terminal 300 transmits the received service to the TV 500 and the TV 500 displays the received service to allow viewers to select desired services.

As such, since the present invention can automatically generate and manage the keyword for each channel and easily retrieve and provide the service associated with the corresponding keyword, the viewers can immediately resolve questions about characters or situations of a presently viewed channel to thereby acquire improved satisfaction.

Referring to FIG. 2, the service providing server 200 includes a receiving unit 210, an extracting unit 220, a storing unit 230, a retrieving unit 240, and a transmitting unit 250.

The receiving unit 210 receives data for each channel from the voice recognizing device 100. Further, the receiving unit may receive data for each channel from a device that converts texts or images to data recognized by the server.

The extracting unit 220 extracts the keyword for each channel from the data. A user may previously define a range of the keyword and an added value for the meaning thereof. For example, the range of the keyword may be limited to nouns such as a name of a corresponding channel program, a character name, a city, a year, a team, and the like, and added values for the nouns may be defined by considering characteristics of programs of sports, dramas, music, movie, and the like.

The storing unit 230 stores the keyword for each channel. Further, electronic program guide (EPG) information for each channel included in the broadcasting stream may be stored together with the keyword. The EPG is configured based on service information (SI) in MPEG-2 transport stream (TS) and includes information of a time, a title, a channel, a genre, a program, and the like.

When the IPTV terminal 300 requests information regarding a predetermined channel, the retrieving unit 240 reads the corresponding information from the storing unit 230 according to the request.

The transmitting unit 250 transfers the read information to the IPTV terminal 300. As a transferring scheme, an XML format or a table scheme used in a broadcasting technology, a section format may be used.

As such, the service provider server 200 transmits an automatically extracted keyword and EPG of the corresponding channel to the IPTV terminal 300. The viewers receive the service retrieval result associated with the keyword as well as the EPG constituted by information of channels, programs, schedules, and the like, to retrieve more accurate information of the presently viewed channel.

According to another exemplary embodiment of the present invention, the transmitting unit 250 requests the keyword for each channel and the information associated with the keyword for each channel and the EPG to the retrieval service provider such as the portal 400.

The receiving unit 210 receives the service retrieval result associated with the keyword and the EPG from the portal 400.

The storing unit 230 stores the keyword, the EPG, and the service retrieval result associated with the keyword and the EPG for each channel.

The retrieving unit 240 is requested the information regarding the predetermined channel from the IPTV terminal 300 and reads the corresponding information from the storing unit 230, and the receiving unit 210 provides the read information to the IPTV terminal 300.

As such, the server 200 provides a previously stored service retrieval result according to the request from the IPTV, and as a result, the IPTV terminal 300 can provide relevant information directly to the viewers without an additional retrieval request to the portal 400, thereby making it possible to reduce a response time.

Referring to FIG. 3, the IPTV terminal 300 includes an input unit 310, a control unit 320, and an output unit 340.

The input unit 310 receives a retrieval request signal, and information regarding at least one of the keyword and the service retrieval result for the channel from the service providing server 200. The information received from the server 200 may further include the EPG information.

The control unit 320 first verifies whether the retrieval request signal is present. The viewers may send the retrieval request signal to the IPTV terminal 300 by using a remote controller. When the retrieval request signal is present, the control unit 320 requests the information regarding the corresponding channel to the server 200. The control unit 320 judges whether the service retrieval result is included in the received information from the server 200 and when the service retrieval result is included, the control unit 320 commands the service retrieval result to be transmitted to the TV 500.

The output unit 340 transmits the request for the information regarding the corresponding channel to the server 200 according to the request from the control unit 320 and transmits the service retrieval result received from the server 200 to the TV 500 according to the command of the control unit 320.

According to another exemplary embodiment of the present invention, the input unit 310 further receives the service retrieval result from the portal 400.

When the service retrieval result is not included in the information received from the server 200, the control unit 320 requests to the portal 400 service retrieval associated with the information received from the input unit 310. The control unit 320 commands the service retrieval result received from the input unit 310 to be transmitted to the TV 500.

The output unit 340 transmits the service retrieval request from the control unit 320, to the portal 400 and transmits the service retrieval result received from the portal 400, to the TV 500 according to the command of the control unit 320.

As such, the IPTV terminal 300 transmits the service retrieval result associated with the EPG and the keyword to the TV 500, and as a result, the viewers can retrieve more accurate information in the corresponding channel even though broadcasters do not input keywords for retrieval into the broadcasting stream or the viewers do not input the keywords directly. Further, when the corresponding service retrieval result is previously stored in the server 200, the IPTV terminal 300 receives the retrieval result directly from the server 200, thereby providing the service retrieval result directly to the viewers without an additional retrieval request for the keyword of the corresponding channel to the portal 400. Accordingly, a retrieval time is decreased, and as a result, viewers' satisfaction can be improved.

Referring to FIG. 4, the IPTV terminal 300 includes an input unit 310, a keyword generating unit 330, an output unit 340, and a control unit 320.

The input unit 310 receives data from the TV 500 and the service retrieval result associated with the keyword from the portal 400. The data may be any one of time, image capture, and text capture data.

The keyword generating unit 330 extracts the keyword from the data received from the TV 500 of the input unit 310. The keyword generating unit 330 may be any one of a voice recognition extracting portion 331, an image capture extracting portion 332, and a text capture extracting portion 333.

The output unit 340 transmits the request for the service retrieval associated with the keyword extracted from the keyword generating unit 330 to the portal 400 and transmits the service retrieval result associated with the keyword of the input unit 310 to the TV 500.

The control unit 320 sends the data of the input unit 310 to the keyword generating unit 330. The control unit 320 sends the data to the voice recognition extracting portion 331 when the data of the input unit 310 is the time, to the image capture extracting portion 332 when the data is the image capture, and to the text capture extracting portion 333 when the data is the text capture. The control unit 320 commands the service retrieval result of the input unit 310 to be transmitted to the TV 500 through the output unit 340.

The time data may be a time interval. For example, the viewer extracts the keyword from the presently viewed channel for 10 minutes from now on to make a service retrieval request associated therewith to the IPTV terminal 300. The voice recognition extracting portion 331 converts voice data of the broadcasting stream during the time interval to extract the keyword. The keyword extracting method is described as above.

When the data is the text capture, the text capture extracting portion 333 analyzes a text code of a region selected by a user in a corresponding frame and converts the text code to a word to extract the keyword. For example, information on a predetermined zone is shown through a broadcasting caption and at this time, when the viewer selects the predetermined zone of the corresponding caption to request retrieval, the text capture extracting portion 333 analyzes the selected zone of the corresponding frame to extract the keyword.

When the data is the image capture, the image capture extracting portion 332 analyzes an image of the region selected by the user in the corresponding frame to extract the keyword. In this case, unlike the voice recognition extracting portion 331 and the text capture extracting portion 333, an image recognition processing process should be performed, but in the present invention, the image recognition processing process is excluded and only the keyword generated by the image capture extracting portion 332 is used.

As described above, when the viewer requests for retrieving the image, text, and voice in the presently viewed channel in real time, the IPTV terminal 300 generates the keyword by user selection and provides a service retrieval result retrieved based thereon, thereby providing a result maximally close to a user's desired result.

Referring to FIG. 5, a method of providing a digital broadcasting service by using automatic keyword generation at the side of the server 200 according to an exemplary embodiment of the present invention will be described. First, the service providing server 200 receives data for each channel from the voice recognizing device 100 (S200).

Next, the server 200 extracts a keyword from the data received from the voice recognizing device 100 (S210). The keyword extracting method is described as above.

Meanwhile, the server 200 requests service retrieval associated with the keyword for each channel to the portal 400 (S220) and receives a service retrieval result from the portal 400 (S230).

The extracted keyword is stored in the storing unit 230 for each channel (S240). In this case, the EPG information for each channel may be stored together with the keyword. Further, the keyword, the EPG, and the service retrieval result may be stored for each channel.

The server 200 receives a request for information regarding a channel from the IPTV terminal 300 (S250), reads the information on the corresponding channel from the storing unit 230 (S260), and transmits the read channel information to the IPTV terminal 300 (S270).

Referring to FIG. 6, a method of providing a digital broadcasting service by using automatic keyword generation at the side of the IPTV terminal 300 according to an exemplary embodiment of the present invention will be described. The IPTV terminal 300 first judges whether a retrieval request signal from the viewer is present (S300).

When the retrieval request signal is present, the IPTV terminal 300 requests the information on the corresponding channel to the server 200 (S310) and receives the information on the channel from the server 200 (S320). The information includes at least one information of the keyword and the service retrieval result and may further include the EPG information.

Meanwhile, the IPTV terminal 300 judges whether the service retrieval result is included in the information received from the server 200 (S330).

When the service retrieval result is not included, the IPTV terminal 300 requests service retrieval associated with the information (the keyword or the keyword and EPG) to the portal 400 (S340) and receives the service retrieval result from the portal 400 (S350).

In addition, the IPTV terminal 300 transmits the service retrieval result received from the server 200 or the portal 400 to the TV 500 (S360).

Referring to FIG. 7, a method of providing a digital broadcasting service by using automatic keyword generation at the side of the IPTV terminal 300 including a keyword generator according to another exemplary embodiment of the present invention will be described. The IPTV terminal 300 first judges whether or not to receive data from the TV 500 (S400). The data which can be received from the TV 500 may be any one of time, text capture, and image capture data.

When the IPTV terminal 300 receives the data, the IPTV terminal 300 judges a type of the data (S410).

When the data is the time, the voice recognition extracting portion 331 generates a keyword based on a voice of a broadcasting stream (S421). When the data is the text capture, the text capture extracting portion 333 generates the keyword based on a text (S423) and when the data is the image capture, the image capture extracting portion 332 generates the keyword based on an image (S422).

The IPTV terminal 300 requests service retrieval associated with the generated keyword to the portal 400 (S430), receives a service retrieval result (S440), and transmits the received service retrieval result to the TV 500 (S450).

According to the exemplary embodiments of the present invention, a keyword is automatically generated from voice, image, or text information of a corresponding channel program. It is possible to retrieve more accurate relevant information of the corresponding program by managing the generated keyword with being mapped with a channel and transferring the corresponding keyword to a retrieval service provider as basic information for retrieving services and contents.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A service providing server, comprising:
a receiving unit receiving data for each channel from a voice recognizing device;
an extracting unit extracting a keyword for each channel from the data;
a storing unit storing the keyword for each channel;
a retrieving unit reading information regarding a corresponding channel from the storing unit in accordance with a request from an IPTV terminal; and
a transmitting unit transmitting the information read by the retrieving unit to the IPTV terminal.

2. The service providing server of claim 1, wherein:
the receiving unit further receives a service retrieval result associated with the keyword for each channel from a portal,
the storing unit further stores the service retrieval result associated with the keyword for each channel received by the receiving unit, and
the transmitting unit further transmits a request for service retrieval associated with the keyword for each channel to the portal.

3. The service providing server of claim 1, wherein the storing unit further stores EPG for each channel.

4. The service providing server of claim 3, wherein:
the receiving unit further receives the service retrieval result associated with the EPG and keyword for each channel from the portal,
the storing unit further stores the service retrieval result of the receiving unit, and
the transmitting unit further transmits the request for the service retrieval associated with the EPG and the keyword for each channel to the portal.

5. An IPTV terminal, comprising:
an input unit receiving (a) a retrieval request signal from a user, and (b) at least one of a keyword and a service retrieval result for a channel from a service providing server;
a control unit requesting information regarding the corresponding channel to the server when the retrieval request signal of (a) is present and commanding the service retrieval result of (b) to be transmitted to a TV when the service retrieval result is included in the information of (b); and
an output unit transmitting the request of the control unit to the server and transmitting the service retrieval result to the TV in accordance with the command of the control unit.

6. The IPTV terminal of claim 5, wherein the information of (b) further includes an EPG.

7. The IPTV terminal of claim 5, wherein:
the input unit further receives the service retrieval result from a portal,
the control unit requests service retrieval associated with the information of (b) to the portal when the service retrieval result is not included in the information of (b) of the input unit, and
the output unit further transmits the request of the control unit to the portal.

8. An IPTV terminal, comprising:
an input unit receiving data from a TV and receiving a service retrieval result associated with a keyword from a portal;
a keyword generating unit extracting the keyword from the data received from the TV of the input unit;
an output unit transmitting a service retrieval request associated with the keyword of the keyword generating unit to the portal and transmitting the service retrieval result of the input unit to the TV; and
a control unit sending the data received from the TV of the input unit to the keyword generating unit and commanding the service retrieval result of the input unit to be transmitted to the TV through the output unit.

9. The IPTV terminal of claim 8, wherein:
the data received from the TV of the input unit is any one of a time, an image capture, and a text capture, and
the keyword generating unit is any one of a voice recognition extracting portion, an image capture extracting portion, and a text capture extracting portion.

10. The IPTV terminal of claim 9, wherein the control unit sends the data to the voice recognition extracting portion when the data received from the TV of the input unit is the time, sends the data to the image capture extracting portion when the data received from the TV of the input unit is the image capture, and sends the data to the text capture extracting portion when the data received from the TV of the input unit is the text capture.

11. A method of providing a digital broadcasting service by using automatic keyword generation performed by a service providing server, the method comprising:
(a) receiving data for each channel from a voice recognizing device;
(b) extracting a keyword for each channel from the data;
(c) storing the keyword in a storing unit;
(d) receiving a request for channel information from an IPTV terminal;
(e) reading the channel information from the storing unit; and
(f) transmitting the read information to the IPTV terminal.

12. The method of claim 11, further comprising:
requesting service retrieval associated with the keyword for each channel to a portal; and
receiving a service retrieval result from the portal,
wherein in step (c), the service retrieval result is further stored.

13. The method of claim 11, wherein in step (c), an EPG for each channel is further stored.

14. The method of claim 13, further comprising:
requesting service retrieval associated with the EPG and the keyword for each channel to the portal; and
receiving a service retrieval result from the portal,
wherein in step (c), the service retrieval result is further stored.

15. A method of providing a digital broadcasting service by using automatic keyword generation performed by an IPTV terminal, the method comprising:
judging whether a retrieval request signal is present;
requesting information regarding a corresponding channel to a server when the signal is present;
receiving at least one information of a keyword and a service retrieval result for the channel from the server;
judging whether the service retrieval result is included in the information received from the server; and
transmitting the service retrieval result to a TV.

16. The method of claim 15, wherein an EPG is further included in the information received from the server.

17. The method of claim 15, further comprising:
requesting service retrieval associated with the information to a portal when the service retrieval result is not included in the information; and
receiving a service retrieval result from the portal.

18. A method of providing a digital broadcasting service by using automatic keyword generation performed by an IPTV terminal, the method comprising:
(a) judging whether or not to receive data from a TV;
(b) extracting a keyword from the data;
(c) requesting service retrieval associated with the keyword to a portal;
(d) receiving a service retrieval result from the portal; and
(e) transmitting the service retrieval result to the TV.

19. The method of claim 18, wherein the data in step (a) is any one of a time, an image capture, and a text capture.

20. The method of claim 19, further comprising:
(f) judging a type of the data received from the TV,
wherein step (b) is any one of extracting the keyword based on a voice, extracting the keyword based on the text capture, and extracting the keyword based on the image capture, and
in step (f), the keyword is extracted based on the voice when the data is the time, the keyword is extracted based on the image capture when the data is the image capture, and the keyword is extracted based on the text capture when the data is the text capture.
